(19) United States
(12) Patent Application Publication
(10) Pub. No.: US 2004/0005457 A1
(43) Pub. Date: Jan. 8, 2004

(54) Methods of improving the softness of fibers and nonwoven webs and fibers and nonwoven webs having improved softness

(75) Inventors: Mary Lucille DeLucia, Roswell, GA (US); Xin Ning, Alpharetta, GA (US); Jaime Braverman, Atlanta, GA (US); Eric Mitchell Johns, Roswell, GA (US); David M. Schertz, Roswell, GA (US); Robert L. Pekrul, Marietta, GA (US); Robert L. Hudson, Las Vegas, NV (US); Soo Gyung Jung, Seoul (KR); JeaSeung Chin, SuWon-City (KR); Kue Young You, Anyang-City (KR); Kyung Hee Cho, Taejon City (KR); Jin Hee Lee, Taejon City (KR)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/188,482

(22) Filed: Jul. 3, 2002

(51) Int. Cl. B32B 5/02; B32B 27/04; B32B 9/00; D04H 5/00; B32B 27/12; B32B 3/06; B05D 1/00; B05D 5/00; D04H 1/00; D04H 3/00; D04H 13/00; D02G 3/00

(52) U.S. Cl. 428/364; 428/365; 428/373; 442/97; 428/102; 427/210

(57) ABSTRACT

The present invention provides a method for producing softer fibers and nonwoven webs that includes forming a mixture comprising (i) a thermoplastic and (ii) an additive selected from the group consisting of polyethylene waxes, glyceryl monostearate, sorbitan tristearate, CATALLOY KS357 MONTELL polyolefin resin, an amide having the chemical structure CH₃(CH₂)₇CH═CH(CH₂)ₓCONH₂ where x is selected from 5-15 and mixtures thereof; forming the mixture into fibers and optionally creating a nonwoven web.

### FIELD OF THE INVENTION

This invention relates to the field of nonwoven fabrics or webs and the manufacture of nonwoven fabrics or webs.

### BACKGROUND

The softness of a nonwoven web is an important factor in applications, such as disposable diapers, in which a nonwoven web is in contact with a wearer for an extended period of time. Various methods of increasing the softness of a nonwoven web are known in the art. These methods include wash softening, mechanical stretching, and topical treatment of the web with softening chemicals. The technique of wash softening the nonwoven web is a time consuming, batch process which does not lend itself to the requirements of industrial production. Additionally, large volumes of water from the washing process must be handled, either by recycling or disposal. Finally, the washed web is wet and must be dried before further handling. Drying is an energy consuming process which is somewhat difficult to control in a commercial setting, sometimes resulting in remelted, glazed or otherwise damaged webs.

Mechanical softening alone by stretching does not provide the degree of softness being sought for some applications. Topical treatments alone also do not provide the degree of softness sought for some applications and have manufacturing constraints. Treatments to increase the softness of a nonwoven web involving both mechanical and chemical means are described in U.S. Pat. No. 5,413,811 to Fitting et al. and U.S. Pat. No. 5,770,531 to Sudduth et al. There still remains a need for producing softer fibers and softer and more cloth-like nonwoven fabrics. There is a need to develop a process of producing soft nonwoven fabrics that is relatively rapid, when compared to wash softening, clean in comparison to topical treating, and suited to economical, large-scale commercial manufacturing.

### SUMMARY

The present invention provides a method for producing a softer fibers, nonwoven webs that includes: forming a mixture that includes (i) a thermoplastic and (ii) an additive selected from the group consisting of polyethylene waxes, glyceryl monostearate, sorbitan tristearate, an olefinic thermoplastic elastomer, an amide having the chemical structure CH₃(CH₂)₇CH═CH(CH₂)ₓCONH₂ where x is selected from 5-15, and mixtures thereof; forming the mixture into fibers; and creating a nonwoven web from the fibers. One suggested group of additives includes an amide having the chemical structure CH₃(CH₂)₇CH═CH(CH₂)ₓCONH₂, where x is selected from 5-15. More desirably, the amide has the chemical structure CH₃(CH₂)₇CH═CH(CH₂)ₓCONH₂, where x is selected from 6-12. And, even more desirably, the amide has the chemical structure CH₃(CH₂)₇CH═CH(CH₂)ₓCONH₂, where x is selected from 8-11. Particular suggested additives include CH₃(CH₂)₇CH═CH(CH₂)₈CONH₂ and CH₃(CH₂)₇CH═CH(CH₂)₁₁CONH₂.

The mixture may include from about 0.05 to 5 weight percent of the additive based on the weight of the thermoplastic. More desirably, the mixture includes from about 0.05 to about 3 weight percent of the additive based on the weight of the thermoplastic. And even more desirably, the mixture includes from about 0.05 to about 1 weight percent of the additive based on the weight of the thermoplastic. The method may further include mechanically softening the nonwoven web or adding a surface treatment to the nonwoven web. The mechanical softening may be accomplished by stretching the nonwoven web by 5 percent or more. Stretching of a nonwoven web improves hand feel and may improve softness as measured by Cup Crush. In addition, topical treatments can be applied to the web to modify hand feel or for other reasons.

The present invention also provides fibers having an exterior surface, including a composition that forms at least a portion of the exterior surface wherein the composition that includes: (i) a thermoplastic; (ii) from about 0.05 to about 5 weight percent of an additive selected from the group consisting of polyethylene waxes, glyceryl monostearate, sorbitan tristearate, an olefinic thermoplastic elastomer, an amide having the chemical structure CH₃(CH₂)₇CH═CH(CH₂)ₓCONH₂ where x is selected from 5-15, and mixtures thereof; (iii) from 0 to about 10 weight percent of an opacifier; (iv) from 0 to about 10 weight percent of an inorganic filler; and (iv) from 0 to about 5 weight percent of a pigment. It is desirable that the composition includes from about 0.05 to about 5 weight percent of the softening additive based on the weight of the polypropylene, copolymer of propylene or mixture thereof, more desirably, from about 0.05 to about 3 weight percent of the softening additive based on the weight of the polypropylene, copolymer of propylene or mixture thereof. A suggested opacifier is titanium dioxide. Suggested inorganic fillers that can sloe be included in the compositions, nonwoven webs, and fibers of the present invention include zinc oxide, kaolin day, calcium carbonate, talc, attapulgite clay and mixtures thereof.

The present invention also provides nonwoven webs comprising fibers, the fibers having an exterior surface and comprising a composition that forms at least a portion of the exterior surface wherein the composition includes: (i) a thermoplastic; (ii) from about 0.05 to about 5 weight percent of an additive selected from the group consisting of a polyethylene wax, glyceryl monostearate, sorbitan tristearate, an olefinic thermoplastic elastomer, an amide having the chemical structure CH₃(CH₂)₇CH═CH(CH₂)ₓCONH₂ where x is selected from 5-15, and mixtures thereof; (iii) from 0 to about 10 weight percent of an opacifier; (iv) from 0 to about 10 weight percent of an inorganic filler; and (v) from 0 to about 5 weight percent of a pigment. The nonwoven web can have a Cup Crush value of less than about 600 grams per millimeter at a basis weight of 15 grams per square meter. The nonwoven may be thermally bonded and have a bond area of from about 10 percent to about 30 percent. Other methods of bonding can be used and include ultrasonic bonding, latex bonding and so forth.

The present invention also includes laminates of such nonwoven webs and provides an outercover for a disposable absorbent product comprising a laminate of such a nonwoven web. Other suggested uses includes bed pads, liners and barrier materials and other components for disposable and absorbent products, for example a disposable, absorbent products such as diaper, bandages and so forth.

### BRIEF DESCRIPTION OF THE DRAWINGS

FIG. 1 is a schematic illustration of an exemplary method of making a spunbonded nonwoven web.

FIG. 2 is a drawing of a bonding pattern known as an Expanded Hansen-Pennings or EHP pattern.

### DEFINITIONS

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers are microfibers which may be continuous or discontinuous, are generally smaller than 10 microns in average diameter (using a sample size of at least 10), and are generally tacky when deposited onto a collecting surface.

As used herein the terms “nonwoven fabric” and nonwoven web” mean a web having a structure of individual fibers or threads which are interlaid, but not in an identifiable manner as in a knitted fabric. Nonwoven fabrics or webs have been formed from many processes such as, for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

As used herein, the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein the terms “spunbonded fibers” and “spunbond fibers” refer to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No.3,502,763 to Hartman, and U.S. Pat. No. 3,542,615 to Dobo et al. Spunbond fibers are generally not tacky when they are deposited onto a collecting surface. Spunbond fibers are generally continuous and have average diameters (using a sample size of at least 10) larger than 7 microns, more particularly, between about 10 and 25 microns.

As used herein, the term “thermal point bonding” involves passing materials (fibers, webs, films, etc.) to be bonded, for example, between a heated calender roll and an anvil roll, a pattern roll and a flat anvil roll or two patterned rolls. The calender roll is usually, though not always, patterned in some way so that the entire fabric is not bonded across its entire surface, and the anvil roll is usually flat. As a result, various patterns for calender rolls have been developed for functional as well as aesthetic reasons. Typically, the percent bonding area varies from around 10 percent to around 30 percent of the area of the fabric laminate. As is well known in the art, thermal point bonding holds the laminate layers together and imparts integrity to each individual layer by bonding filaments and/or fibers within each layer.

As used herein, “ultrasonic bonding” means a process performed, for example, by passing the web between a sonic horn and anvil roll as illustrated in U.S. Pat. No. 4,374,888 to Bornslaeger.

As used herein, any given range is intended to include any and all lesser included ranges. For example, a range of from 25-75 would also include 30-75, 45-60, 27-39 and so forth.

Test Methods

Basis Weight:

The basis weight of a nonwoven fabric or web is the weight of a unit area of nonwoven fabric and is usually expressed in ounces of material per square yard (osy) or grams per square meter (gsm). (Note that to convert from osy to gsm, multiply osy by 33.91).

Softness/Cup Crush Test:

The softness of a nonwoven fabric may be measured according to the “cup crush” test. The cup crush test evaluates fabric stiffness by measuring the peak load (also called the “cup crush load” or just “cup crush”) and energy required to crush a specimen and in turn quantify softness of the specimen. The specimen is formed inside a forming cup. The forming cup and the specimen are then placed on a load plate which is mounted on a tensile tester. A foot descends through the open end of the forming cup and “crushes” the cup-shaped specimen inside. Peak load (grams) and Energy (g-mm) are the results. The results are a manifestation of the stiffness of the material. The stiffer the material, the higher the peak load and energy values.

The tensile tester is equipped with a computerized data-acquisition system that is capable of calculating peak load and energy between two pre-determined distances (15-60 millimeters) in a compression mode. A suitable device for measuring cup crush is a model FTD-G-500 load cell (500 gram range) available from the Schaevitz Company, Pennsauken, N.J. Tensile Testers and load cells can be obtained from Instron Corporation, Canton, Mass. 02021 or Sintech, Inc., P.O. Box 14226, Research Triangle Park, N.C. 27709-4226.

The energy measured is that required for a 4.5 cm diameter hemispherically shaped foot to crush a 23 cm by 23 cm piece of fabric shaped into an approximately 6.5 cm diameter by 6.5 cm tall inverted cup while the cup shaped fabric is surrounded by an approximately 6.5 cm diameter cylinder (forming cup) to maintain a uniform deformation of the cup shaped fabric during testing. An average of 10 readings is used. The test is conducted in a standard laboratory atmosphere of 23±2° C. and 50±5% relative humidity. The material should be allowed to reach ambient temperature before testing. The specimen is prepared by placing a retaining ring over a forming stand. The material is then placed over the forming stand. A forming cup is placed over the specimen and the forming stand to conform the specimen into the cup shape. The retaining ring engages the forming cup to secure the specimen in the forming cup. The forming cup is removed with the now-formed specimen inside. The specimen is secured within the forming cup by the retaining ring. The specimen, forming cup, and retaining ring are inverted and placed in the tensile tester. The foot and the forming cup are aligned in the tensile tester to avoid contact between the cup walls and the foot which could affect the readings. The foot passes through an opening in the bottom of the inverted forming cup to crush the cup-shaped sample inside. The peak load is measured while the foot is descending at a rate of about 406 mm per minute and is measured in grams. The cup crush test also yields a value for the total energy required to crush a sample (the “cup crush energy”) which is the energy from the start of the test to the peak load point, i.e. the area under the curve formed by the load in grams on one axis and the distance the foot travels in millimeters on the other. Cup crush energy is therefore reported in gm-mm. Lower cup crush values indicate a softer laminate.

Peak Load/Nonwovens Tensile Strength (Modified Edana 20.2.89):

This test method examines the behavior of nonwoven fabrics when subjected to tensile stress. Tensile strength is a measure of breaking strength and elongation or strain of a fabric when subjected to unidirectional stress. This test is known in the art and conforms to the specifications of European Disposables and Nonwoven Association (EDANA) Tensile Strength Method 20.2-89 with the following modifications: the jaw separation is 100 mm instead of 200 mm and the rate of extension is 200 mm/min instead of 100 mm/min. The results are expressed in Newtons to break and percent stretch before breakage. Higher numbers indicate a stronger, more stretchable fabric. The term “load” means the maximum load or force, expressed in units of weight, required to break or rupture the specimen in a tensile test. The term “total energy” means the total energy under a load versus elongation curve as expressed in weight-length units. The term “elongation” means the increase in length of a specimen during a tensile test. The tensile test uses two clamps, each having two jaws with each jaw having a facing in contact with the sample. The clamps hold the material in the same plane, usually vertically, separated by 100 mm and move apart at a specified rate of extension. Samples are conditioned for 24 hours and are tested at 23° C. and 50% relative humidity. Values for tensile strength and elongation are obtained using a sample size of 50 mm wide and 200 mm long with a jaw facing size of 25 mm by 25 mm, and a constant rate of extension of 200 mm/min. The sample is wider than the clamp jaws to give results representative of effective strength of fibers in the clamped width combined with additional strength contributed by adjacent fibers in the fabric. The specimen is clamped in, for example, a Sintech 2 tester, available from the Sintech Corporation, 1001 Sheldon Dr., Cary, N.C. 27513, an Instron Model™, available from the Instron Corporation, 2500 Washington St., Canton, Mass. 02021, or a Thwing-Albert Model INTELLECT II available from the Thwing-Albert Instrument Co., 10960 Dutton Rd., Philadelphia, Pa. 19154. This closely simulates fabric stress conditions in actual use. Results are reported as an average of four specimens and may be performed with the specimen in the cross direction (CD) or the machine direction (MD).

Martindale Abrasion Test:

This test measures the relative resistance to abrasion of a fabric. The test results are reported on a scale of 1 to 5, with 5 being the least wear and 1 the most, after 40 cycles with a weight of 1.3 pounds per square inch. The test is carried out with a Martindale Wear and Abrasion Tester such as Model no.103 or Model no. 403 available from James H. Heal & Company, Ltd. of West Yorkshire, England. The abradant used is a 36 inch by 4 inch by 0.05 thick silicone rubber wheel reinforced with fiberglass having a rubber surface hardness 81A Durometer, Shore A of 81 plus or minus 9. The abradant is available from Flight Insulation Inc., a distributor for Connecticut Hard Rubber, 925 Industrial Park, Nebr., Marietta, Ga. 30065.

### DETAILED DESCRIPTION

The present invention relates to improving the softness of fibers and nonwoven webs, particularly melt spun fibers and spunbonded nonwoven webs. Soft, cloth-like nonwoven fabrics are desirable as a component in many commercial products including for example, absorbent articles such as wipers, veterinary products such as bandages, and personal care products. Softness and cloth-like feel are particularly desirable in personal care products. Examples of personal care products include diapers, training pants, swimwear, feminine hygiene products such as sanitary napkins, pantiliners and tampons, incontinence garments and devices, wound dressings, bandages, absorbent pads and so forth. An example of a diaper is described and illustrated in PCT International Application WO 00/20208 and is hereby incorporated by reference herein in its entirety. These products typically include a bodyside liner, and outercover and an absorbent core disposed between the bodyside liner and the outercover. Nonwoven fabrics and fibers can be used to form these components or portions of these components. It is desirable to improve the softness and feel of fibers and nonwoven fabrics components that form any portion of a personal care article or other absorbent product.

Meltblown and spunbond processes are often used to produce nonwoven fabrics. Generally, the process for making spunbonded nonwoven fabrics includes extruding thermoplastic material through a spinneret, quenching and drawing the extruded material into filaments with a stream of high-velocity air to form a random web on a forming surface. Such a method is referred to as meltspinning. Spunbond processes are generally defined in numerous patents including, for example: U.S. Pat. No. 3,802,817 to Matsuki et al.; U.S. Pat. No.4,692,618 to Dorschner, et al.; U.S. Pat. No. 4,340,563 to Appel, et al.; U.S. Pat. Nos. 3,338,992 and 3,341,394 to Kinney; U.S. Pat. No. 3,502,538 to Levy; U.S. Pat. Nos. 3,502,763 and 3,909,009 to Hartmann; U.S. Pat. No. 3,542,615 to Dobo, et al.; and Canadian Patent No. 803,714 to Harmon.

The present invention provides a method of improving the softness of fibers and nonwoven webs that includes the use of one or more of the following additives: polyethylene waxes such as a polyethylene wax, glyceryl monostearate, sorbitan tristearate, an olefinic thermoplastic elastomer or an amide having the chemical structure CH₃(CH₂)₇CH═CH(CH₂)ₓCONH₂ where x is selected from 5-15. The additive(s) is applied to one or more of the thermoplastic materials that are used to form the fibers and/or nonwoven web. One such additive is erucamide CH₃(CH₂)₇CH═CH(CH₂)₁₁CONH₂ which may also be referred to as cis-13-docosenoamide. Erucamide is commercially available from Akzo Nobel Amides Co. Ltd. under the trade name ARMOSLIP E. ARMOSLIP E is marketed as a slip or antiblocking agent for polyolefins. Another suggested amide additives include oleylamide CH₃(CH₂)₇CH═CH(CH₂)₈CONH₂ and oleamide N-9-octadecenyl-hexadecanamide) is CH₃(CH₂)₇CH═CH(CH₂)₇CONH₂. A suggested polyethylene was is AC16 polyethylene wax refers to a 2500 amu linear, low density polyethylene marketed as AC16 by Allied Signal of Morristown, N.J. Glyceryl monostearate is HOCH₂—CHOH—CH₂O—C═O(CH₂)₁₆CH₃. Sorbitan tristearate has a 965 amu, an HLB of 2.1 and is sold by ICI Americas under the tradename SPAN 65. Another suggested additive is an olefinic thermoplastic elastomer such as KS357P CATALLOY polymer from Himont U.S.A. KS357P CATALLOY polymer is an olefinic thermoplastic elastomer or TPO multistep reactor product wherein an amorphous ethylene propylene random copolymer is molecularly dispersed in a predominately semicrystalline high polypropylene monomer/low ethylene monomer continuous matrix. An example of a method of making such a TPO is described in greater detail in U.S. Pat. No. 5,300,365 to Ogale.

Desirably and for economy, the softness of the nonwoven webs and fibers can be improved by incorporating less than about 5 percent by weight of one or more of the above-listed additives in the final composition from which the fibers or nonwoven are extruded or otherwise formed. More desirably, the softness of the nonwoven webs and fibers can be improved by incorporating less than 3 and even less than 1 percent by weight of one or more of the above-listed additives in the final melt composition form which the fibers or nonwoven are made. Suggested amounts of additive that can be included in the final composition include from about 0.1 to about 0.3 weight percent of additive based on the amount of resin or mixture of resins that are used to produce the nonwoven web and/or fibers. The additive(s) may be added neat through the ports of the extruder prior to fiber formation. However, it is suggested the additive or mixture of additives is compounded with the resin as a concentrate into the melted resin. Desirably, the additive is added to melted resin using a masterbatch of the additive in the base polymer(s) and is uniformly distributed in the base polymer(s).

The present invention provides a method of producing softer fibers, nonwoven fabrics and laminates and other combinations by adding a certain additive(s) to a thermoplastic material that is used to form the fibers or fabrics. Suggested thermoplastic materials include polyesters, such as poly(ethylene terephthalate), and polyolefins. Suggested polyolefins include polyolefin resins, for example: polyethylene resins, polypropylene resins, and copolymers of ethylene and/or propylene. Suggested polypropylene resins include, but are not limited to, such homopolymers and copolymers of propylene, controlled rheology polypropylene, and metallocene catalyzed polypropylene. One particular suggested polypropylene resin is polypropylene resin 3155 commercials available from Exxon Mobil of Houston, Tex. Another suggested polypropylene is COPOLY 6D43 resin by Dow Chemical Company of Midland, Mich., a random copolymer of propylene having about 3 weight percent of ethylene randomly incorporated into the polypropylene backbone and attached to the polypropylene backbone.

Soft nonwoven fabrics of the present invention can be further softened by post treating the nonwoven fabric, for example by mechanical softening and/or topical treatment. In one embodiment, the present invention provides a method of improving the softness of a nonwoven web that includes post treating a nonwoven web that is formed from a composition that includes one or more of the above-listed additives. An exemplary method of post treatment of a nonwoven web to improve softness that involves mechanically treating, specifically stretching, a nonwoven web is disclosed in U.S. Pat. No. 5,770,531 which is hereby incorporated by reference herein in its entirety. Suggested surface treatments include AHCOVEL N-62 a blend of ethoxylated hydrogenated castor oil and sorbitan monooleate available from ICI and Triton X-102 an alkylphenol ethoxylate surfactant available from Union Carbide. Surface treatments and both surfactants are described in greater detail in U.S. Pat. No. 6,060,636 which is hereby incorporated by reference herein. Other surface treatments and methods of treating surfaces to improve the wettability of the surfaces are described in U.S. Pat. Nos. 5,814,567 and 6,017,832 which are hereby incorporated by reference herein. Other suggested surfactants include Cirrasol PP842 and Cirrasol PP843, both of which are made by Uniqema of Wilmington, Del. These surfactants can be used to enhance treatment uniformity or other properties of the nonwoven web and fibers of the present invention. The fibers and webs may also be treated with a surfactant composition or other compositions that includes a skin wellness additive such as vitamin or aloe vera that can be combined with an AHCOVEL surfactant composition.

Mechanical treatment of a web may be carried out by a number of different methods such as micro creping, cold embossing, beater bar treatment, stretching, neckstretching, un-necking, and combinations thereof. As used herein, the terms “necking” or “neck stretching” interchangeably refer to a method of elongating a nonwoven fabric, generally in the machine direction, to reduce its width in a controlled manner to a desired amount. The controlled stretching may take place under cool, room temperature or greater temperatures and is limited to an increase in overall dimension in the direction being stretched up to the elongation required to break the fabric, which in most cases is about 1.2 to 1.4 times. When relaxed, the web retracts toward its original dimensions. Such a process is disclosed, for example, in U.S. Pat. No. 4,443,513 to Meitner and Notheis, U.S. Pat. Nos. 4,965,122, 4,981,747 and 5,114,781 to Morman and U.S. Pat. No. 5,244,482 to Hassenboehler Jr. et al. As used herein the term “un-necking” means a process applied to a reversibly necked material to extend it to at least its original, pre-necked dimensions by the application of a stretching force in a direction generally perpendicular to the direction of the original stretching force which causes it to recover to within at least about 50 percent of its reversibly necked dimensions upon release of the stretching force.

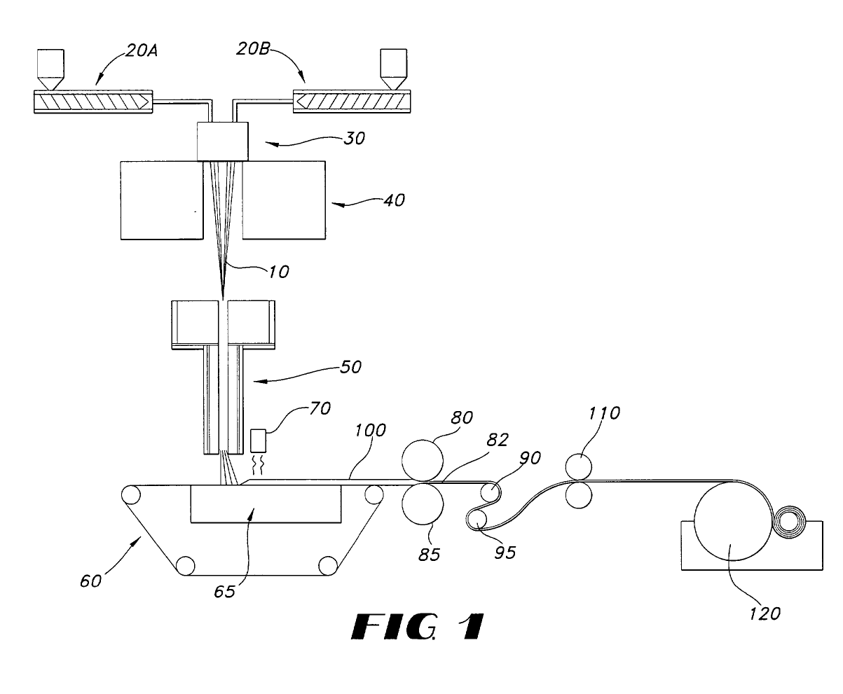

Other methods known in the art to mechanically soften a nonwoven web may also be used. A method of mechanical, post treatment of a web by stretching in the machine direction (MD) is illustrated in FIG. 1. Post treatment may also be achieved by stretching in the cross direction (CD) using a tenter frame. An example of stretching in the CD-direction is also described in U.S. Pat. No. 5,770,531. Another method of mechanical, post treatment of a web includes creping of the nonwoven web. An example of creping a nonwoven web that mechanically softens the nonwoven web is describe in U.S. Pat. No. 6,197,404 which is hereby incorporated by reference herein. Other methods include grooved roll stretching.

Nonwoven webs and fibers of the present invention may further include one or more additional additives such as colorants, pigments, dyes, opacifiers, UV stabilizers, fire retardant compositions, stabilizers and so forth in addition to the softening agent. The additional additive(s) can be incorporated contemporaneously into the thermoplastic resin with the softening agent or separately. For example, an opacifier such as titanium dioxide or gypsum can be added to the composition to provide opacity. A suggested opacifier is titanium dioxide and can be obtained in 50 percent concentrate form in polypropylene to be incorporated in polypropylene-based compositions. Additional inorganic fillers can be added to further improve material softness and/or aesthetic appearance. Inorganic fillers and methods of improving the aesthetic appearance of nonwoven webs using inorganic fillers are disclosed in International Application WO 00/00680 which is also hereby incorporated by reference herein in its entirety. Various additives, fillers and post treatments may be selected to further improve the fibers and webs or alter properties as desired.

In one embodiment, the present invention provides a method of improving the softness of multicomponent fibers and nonwoven webs that include multicomponent fibers in which one of the components that forms that exterior surface of the fibers is a polypropylene or a copolymer of polypropylene and at least one of the above-listed additives. The multicomponent fibers include bicomponent fibers and other multicomponent fibers having any known configurations, for example fibers having side-by-side and sheath-core configurations, particularly sheath-core fibers having concentric and eccentric configurations. Multicomponent meltspun nonwoven fabrics and methods of making multicomponent meltspun nonwoven fabrics are known and are described in U.S. Pat. No. 5,382,400 issued to Pike et al. which is herein incorporated by reference in its entirety. An example of a multicomponent fiber of the present invention includes a fiber having a polypropylene core and a polyethylene sheath in which the polyethylene sheath is made from a composition including one of the additives or a mixture of additives. In a side-by-side bicomponent fiber, one or both of the side-by-side components can include one or more of the additives for improving softness. In addition, fibers and nonwoven fabrics of the present invention can include multiconstituent fibers that are made from a blend of two or more polymers. The polymers can be compatible or incompatible. Multiconsituent fibers and nonwoven fabrics are known and are disclosed in U.S. Pat. No. 5,534,335 issued to Everhart et al. which is herein incorporated by reference in its entirety. Furthermore, fibers and nonwoven fabrics of the present invention may include round, trilobal, pentalobal, and hollow fiber and fibers of any other shape or cross section.

Turning to FIG. 1, an exemplary method of making a nonwoven web according the present invention is described. Although FIG. 1 illustrates a process line that is arranged to produce bicomponent continuous filaments, it should be understood that the present invention comprehends nonwoven fabrics made with single component filaments, mixtures of filaments including cellulose-based filaments, and/or multicomponent filaments having more than two components. For example, a nonwoven fabric of the present invention may include additional fibers, such as pulp fibers, and may include filaments having three or four or more components, one of which contains a softening additive as described herein. The illustrated process line includes two extruders 20A and 20B. The first extruder 20A can be used to extrude a first polymer component A and a second separate extruder 20B can be used to extrude a second polymer component B or the same polymer as polymer component A. Polymer component A is fed into the respective extruder from a first hopper and, optionally, polymer component B is fed into the respective extruder from a second hopper. The polymer component(s) are fed from the extruders 20A and 20B through respective polymer conduits to a spinneret 30. Spinnerets for extruding bicomponent filaments are known to those skilled in the art and thus are not described here in detail. Examples of bicomponent spinning are described in.

Generally described, the spinneret 30 includes a housing containing a spin pack which includes a plurality of plates stacked one on top of the other with a pattern of openings arranged to create flow paths for directing polymer components A and B separately through the spinneret 30. The spinneret 30 has openings arranged in one or more rows. The spinneret openings form a downwardly extending curtain of filaments 10 when the polymers are extruded through the spinneret 30. Spinneret 30 may be arranged to form side-by-side or sheath/core bicomponent filaments or other types of filaments. The process line also includes a quench air blower 40 positioned adjacent the curtain of filaments extending from the spinneret 30. Air from the quench blower 40 quenches the filaments extending from the spinneret 30. The quench air can be directed from one side of the filament curtain or both sides of the filament curtain as illustrated.

A fiber draw unit (FDU) or aspirator 50 is positioned below the quench air blower 40 and receives the quenched filaments. Fiber draw units or aspirators for use in melt spinning polymers are also known. Suitable fiber draw units for use in the process of the present invention include a linear fiber aspirator of the type described and illustrated in U.S. Pat. No. 3,802,817, linear draw system of the type described and illustrated in U.S. Pat. No. 4,340,563 and eductive guns of the type described and illustrated in U.S. Pat. Nos. 3,692,618 and 3,423,266, all of which are incorporated herein by reference. Generally, the fiber draw unit 50 includes an elongate vertical passage through which filaments are drawn by aspirating air entering from the sides of the passage and flowing downwardly through the passage.

A foraminous, forming surface 60 is positioned below the fiber draw unit 50 to collect and receive continuous filaments from the outlet opening of the fiber draw unit. The forming surface 60 may be a belt that travels around guide rollers as illustrated to provide a continuous process. Desirably, a vacuum 65 is positioned below the forming surface 60 where the filaments are deposited to draw the filaments against the forming surface 60. Although the forming surface 60 is illustrated as a belt in FIG. 1, it is understood that the forming surface can also be in other forms, for example a drum.

In the embodiment illustrated in FIG. 1, the filaments that have been collected on a forming surface are exposed to a hot-air knife (HAK) 70 that provides some integrity to the web so that the web can be transferred to another wire. Transfer of a web can be accomplished without the use of a HAK and by other methods including but not limited to, vacuum transfer, compaction or compression rolls and other mechanical means. The web is then transferred to a second surface 200, for example a bonding wire. The process line may also include one or more bonding devices such as a heated calender roll 85 and a patterned anvil roll 80. Through-air bonders are known and are therefore not disclosed here in detail. Alternatively or in addition, a more conventional through-air bonder that includes a perforated roller may be included in the methods of the present invention. Lastly, the process line includes a winding roll 90 for taking up the nonwoven fabric.

In an exemplary embodiment, the hopper of extruder 20A was filled with a mixture of a polypropylene resin, a concentrate containing ERUCAMIDE as the softening agent and an optional opacifier. The polymer resin, additive and the other optional component(s) are melted and extruded by the respective extruders through polymer conduits and the spinneret 30. Although the temperatures of the molten polymers vary depending on the polymers used, when polypropylene and RCP are used, the desirable temperatures of the polymers range from about 370° F. to about 530° F. and desirably range from 400° F. to about 450° F. As the extruded filaments 10 extend below the spinneret 30, a stream of air from the quench blower 40 at least partially quenches the filaments and may be used to develop a latent crimp in the filament if desired. Desirably, the quench air flows in a direction substantially perpendicular to the length of the filaments at a temperature of from about 45° F. to about 90° F. and at a velocity from about 100 feet per minute to about 400 feet per minute. The filaments should be quenched sufficiently before being collected on the forming surface 60 so that the filaments can be arranged by forced air passing through the filaments and the forming surface. Quenching the filaments reduces the tackiness of the filaments so that the filaments do not adhere to one another too tightly before being bonded and can be moved or arranged on a forming surface during collection of the filaments on the forming surface and formation of the web. After quenching, the filaments are drawn into the vertical passage of the fiber draw unit 50 by a flow of air through the fiber draw unit.

In the embodiments illustrated in FIG. 1 and described in the Examples below, filaments were formed through the outlet opening of the fiber draw unit 50 and then deposited onto a traveling forming surface 60. As the filaments 10 contact the forming surface 60, a vacuum 65 box draws the filaments against the forming surface to form an unbonded, nonwoven web of continuous filaments 100. After the filaments are collected on a forming surface, the nonwoven web can be thermally point bonded with a heated calender roll 80 and an anvil roll 85 to form a thermally point-bonded, integrated fabric 82. After bonding, the fabric can be optionally stretched over rollers 90 and 95 to provide improved had feel. The amount of stretch can be varied by a pair of rollers 110. The finished fabric may be transferred to a winding roll 120 and collected or, alternatively, directed for further processing or treatment. The nonwoven web may be treated before it is wound onto the winding roll 120. The nonwoven web is ready for further treatment or use. The nonwoven web can be treated with an additive, such as vitamin E or aloe vera, that improves skin wellness.

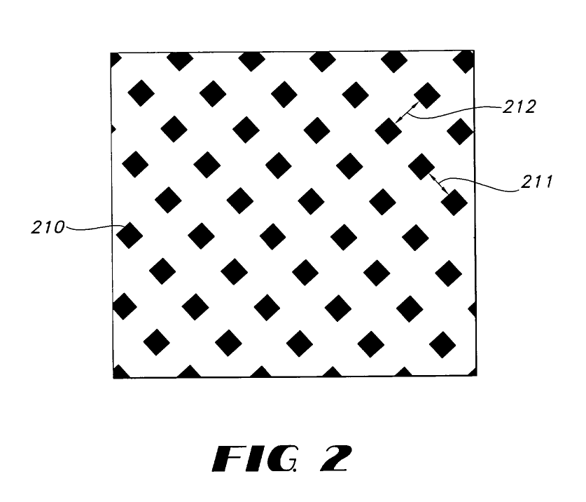

The nonwoven web can be bonded by various bonding methods including, but not limited to, through-air-bonding, ultrasonic bonding, thermal point bonding, latex bonding and other known bonding techniques. The bonding pattern may be selected to improve physical properties, the aesthetic appearance and/or the feel of the nonwoven fabric. The bond area may vary. Suggested bond areas range from about 5 percent to 30 percent of the surface area of the nonwoven web. More desirably, suggested bond areas can range from about 10 to about 20 percent. Suggested bonding patterns include an Expanded Hansen-Pennings (EHP) pattern and more desirably a wire weave pattern. A suggested EHP pattern is illustrated in FIG. 2 and has a pattern of square tapered points 210 with a wide spacing 211 of 0.0664 inches and a narrow spacing 212 of 0.0526 inches. The pins are all 0.037 inches across, at a pin density of about 107 pins per square inch and provide a bond area of from about 10 to about 20 percent. A suggested wire weave pattern is has elements of length of 0.031 inches and width of 0.016 inches for an element aspect ratio (0.031/0.016) of about 2. Expanded Hansen and Pennings patterns, wire weave patterns and other bond patterns are further described in U.S. Pat. Nos. 5,964,742; 5,620,779 and 3,855,046 which are hereby incorporated by reference herein.

The nonwoven is desirably bonded, more desirably is thermally point bonded at thermally point bonded. Thermal point bonding involves passing a fabric or web of fibers to be bonded, for example a nonwoven web of the present invention, between, for example a heated calender roll and an anvil roll. The calender roll is usually, though not always, patterned in some way so that the entire fabric is not bonded across its entire surface, and the anvil roll is usually flat. These bonding rolls can include a pattern roll and anvil roll in combination or two pattern rolls. As a result, various patterns for rolls have been developed for functional as well as aesthetic reasons. One example of a pattern known as a “wire weave” pattern is illustrated in FIG. 3 of U.S. Pat. No. 5,964,742 to McCormack et al. The wire weave pattern looks like a window screen and has about an 18 percent bond area. Other common patterns include a diamond pattern with repeating and slightly offset diamonds with about a 16 percent bond area. Typically, the percent bonding area varies from around 10 percent to around 30 percent of the area of the fabric laminate web. As in well known in the art, the spot bonding holds the laminate layers together as well as imparts integrity to each individual layer by bonding filaments and/or fibers within each layer. The bonding pattern can be varied, as well as the pin size, pin density and spacing and distance between pins.

Fibers and nonwoven web of the present invention may be included in multilayer materials or a composite material including as a component fibers including one of the above-listed additives as a component For example, an outer cover can be formed from a laminate that includes a breathable film and a spunbonded nonwoven that includes one of the above-listed additives. Nonwoven webs of the present invention may be used a facing material or layer in various components such as side barriers, elastomeric diaper ears, waist bands and other components of disposable, absorbent products.

FIG. 1 illustrates optional in-line stretching to further soften the nonwoven and/or improve aesthetics. The nonwoven web 100 is provided with a bond pattern by pattern roll 80 and anvil roll 85 prior to stretching. The fibers of nonwoven web 100 should be joined by interfiber bonding to form a coherent web structure which is able to withstand stretching. Interfiber bonding may be produced by entanglement between individual fibers. The fiber entangling may be inherent in the nonwoven web forming process or may be generated or increased by processes such as, for example, hydraulic entangling or needle punching. Alternatively and/or additionally a bonding agent may be used to increase the desired bonding or bonding may be accomplished by ultrasonic, print or thermal point bonding. After passing through a nip 82 formed by the arrangement of pattern roll 80 and anvil roll 85, the nonwoven web 100 passes over a series of steam cans 90 and 95 in an S loop; one or more S loops may be provided. The steam cans 90 and 95 typically have an outside diameter of about 24 inches although other sized cans may be used. The contact time or residence time of the nonwoven web 100 on the steam cans to effect heat treatment will vary depending on factors such as, for example, steam can temperature, and type and/or basis weight of material. For example, a stretched nonwoven web of polypropylene may be passed over a series of steam cans heated to a measured temperature from room temperature to about 150° C. (302° F.) for a contact time of from about 1 to about 300 seconds to effect heat treatment. More particularly, the temperature may range from about 100° C. to about 135° C. and the residence time may range from about 2 to about 50 seconds. Because the peripheral linear speed of the drive rollers 110 and 120 is controlled to be lower than the peripheral linear speed of the steam cans 90 and 95, the nonwoven web 100 is tensioned between the steam cans 90 and 95 and the drive rollers 110 and 120. By adjusting the difference in the speeds of the rollers 110 and 120, the nonwoven web 100 is tensioned so that it stretches and possibly necks by a desired amount from a first, starting, unstretched length to a second length and is maintained in such stretched condition while passing over the heated steam cans 90 and 95. This action imparts memory of the stretched condition to the nonwoven web 100. The nonwoven web 100 may be wound onto a roll 120 for uptake and storage or can be further treated. For example, a nonwoven web of the present invention may be treated with a surfactant or other surface treatment to alter the surface properties of the nonwoven web. Again, surfactant treatments and methods of treating surfaces to improve the wettability of the surfaces are described in U.S. Pat. Nos. 5,814,567 and 6,017,832. Other beneficial agents, such as agents that have a skin wellness benefit may be added to the materials of the present invention.

A nonwoven web of the present invention may be zoned and only a portion of the nonwoven web may include an additive of the present invention. Furthermore, a nonwoven web of the present invention may be treated with an optional surface or mechanical treatment and only a portion of a nonwoven web may be post treated with an optional surface or mechanical treatment.

### EXAMPLE A

A comparative example was prepared generally in accordance with FIG. 1 but without stretching by blending a composition of 99 weight percent polypropylene resin 3155 obtained from Exxon and 1 weight percent titanium dioxide. The blended composition was melt extruded into a spunbonded nonmoven web at about 440° F. The spin pack was set at about 450° F. Process conditions were set to produce fibers having an average weight of about 2.2 denier per filament (dpf). The Hot-Air-Knife air (HAK) temperature set at about 340° F. and the calender roll set at 315° F. The spunbonded nonwoven fabric was thermally point bonded using a bond roll having a wire weave pattern and 18 percent bond pattern. Line speed was adjusted to produce a fabric having a basis weight of about 0.5 ounces per square yard (osy).

### EXAMPLE 1

An example of a nonwoven web that is softer by the addition of a softening agent was prepared by blending a melt composition consisting of 97 weight percent polypropylene resin 3155, 2 weight percent of a 10 weight percent Erucamide concentrate and 1 weight percent titanium dioxide. Example 1 was produced under the same process conditions as Example A above.

### EXAMPLE B

A second comparative example was prepared by 99 weight percent random copolymer polypropylene resin 6D43 available from Dow Chemical and 1 weight percent titanium dioxide. The blended composition was melt extruded into a spunbonded nonwoven web at about 390° F. The spin pack was set at about 410° F. Process conditions were set to produce fibers having an average weight of about 2.2 denier per foot (dpf). The Hot-Air-Knife air (HAK) temperature set at about 300° F. and the calender roll set at 250° F. The spunbonded nonwoven fabric was thermally point bonded using a bond roll having a wire weave pattern and 18 percent bond pattern. Line speed was adjusted to produce a fabric having a basis weight of about 0.5 ounces per square yard (osy).

### EXAMPLE 2

A second example of a nonwoven web that is softened by the addition of 0.2 weight percent of a softening agent was prepared by blending a melt composition consisting of 97 weight percent random copolymer polypropylene resin 6D43, 2 weight percent of a 10 weight percent Erucamide concentrate and 1 weight percent titanium dioxide. Example 2 was produced under the same process conditions as Example B above.

### EXAMPLE C

Another comparative example was prepared by blending a composition of 99 weight percent polypropylene resin 3155 obtained from Exxon and 1 weight percent titanium dioxide. Otherwise, Example C was produced under the same process conditions as Example A above except that the basis weight of the nonwoven that was produced was 15.4 grams per square meter (gsm) in this comparative example, Example C.

### EXAMPLE D

An example of a nonwoven that is softened by mechanical treatment was prepared generally in accordance with FIG. 1 by stretching a nonwoven web made from the composition of Example C by 10 percent. Otherwise, Example D was produced under the same process conditions as Example C above.

### EXAMPLE E

Another example of a nonwoven that is softened by mechanical treatment was prepared by stretching a nonwoven web made from the composition of Example C by 20 percent. Otherwise, Example E was produced under the same process conditions as Example C above.

### EXAMPLE 3

An example of a nonwoven web that is softened by the addition of 0.2 weight percent of a softening agent was prepared from the composition of Example 1. Otherwise, Example 3 was produced under the same process conditions as Example 1 above except that the line speed was adjusted to produce a nonwoven with a basis weight of about 16.0 grams per square meter (gsm).

### EXAMPLE 4

An example of a nonwoven web that is softened by both mechanical treatment and the addition of 0.2 weight percent of a softening agent was prepared by stretching a nonwoven web made from the composition of Example 1 by 20 percent. Otherwise, Example 4 was produced under the same process conditions as Example 3 above.

### EXAMPLE F

Another comparative example was prepared by blending a composition of 99 weight percent random copolymer polypropylene resin 6D43 available from Dow Chemical and 1 weight percent titanium dioxide. Otherwise, Example F was produced under the same process conditions as Example B above except that the basis weight of the nonwoven that was produced was 14.6 grams per square meter (gsm) in this comparative example, Example F.

### EXAMPLE G

Another example of a nonwoven that is softened by mechanical treatment was prepared by stretching a nonwoven web made from the composition of Example F by 10 percent. Otherwise, Example G was produced under the same process conditions as Example F above.

### EXAMPLE H

Another example of a nonwoven that is softened by mechanical treatment was prepared by stretching a nonwoven web made from the composition of Example F by 20 percent. Otherwise, Example H was produced under the same process conditions as Example F above.

### EXAMPLE 5

Another example of a nonwoven web that is softened by the addition of 0.2 weight percent of a softening agent was prepared from the composition of Example 2 except that the line speed was adjusted to produce a nonwoven having a basis weight of bout 15.9 grams per square meter (gsm). Otherwise, Example 5 was produced under the same process conditions as Example 2 above.

### EXAMPLE 6

A second example of a nonwoven web that is softened by mechanical treatment and the addition of 0.2 weight percent of a softening agent was prepared by stretching a nonwoven web made from the composition of Example 2 by 20 percent. Otherwise, Example 4 was produced under the same process conditions as Example F above.

### EXAMPLE 7

Another example of a nonwoven web that is softened by the addition of 2.5 weight percent of a softening agent, CATALLOY KS357P MONTELL polyolefin resin obtained from Himont U.S.A., can be prepared similar to Example 1 by blending with 2.5 weight percent of CATALLOY KS357P MONTELL polyolefin resin, 4 weight percent of SCC-4837 a 50 weight percent concentrate of titanium dioxide in polypropylene and 93.5 weight percent of polypropylene resin. Otherwise, Example 11 was produced under the same process conditions as Example 1 above.

### EXAMPLE 8

Another example of a nonwoven web that is softened by the addition of 2.5 weight percent of a softening agent, AC16 polyethylene wax obtained from Allied Signal, can be prepared similar to Example 1 by blending with 2.5 weight percent of AC16 polyethylene wax, 4 weight percent of SCC-4837 a 50 weight percent concentrate of titanium dioxide in polypropylene and 93.5 weight percent of polypropylene resin. Otherwise, Example 12 was produced under the same process conditions as Example 1 above.

Several of the Examples were tested for basis weight, softness (Cup Crush) and tensile strength in the machine direction (Peak Load) using to the test procedures described below. The results of these tests are presented in Table 1 below. A decrease in Cup Crush is desirable. Increased tensile strength or Peak Load is desirable in applications where strength is important and small decreases in strength are acceptable in application in which increased softness is particularly desirable.

TABLE 1

| Example | Basis Weight | Cup Crush | Peak Load in MD | Martindale |
|---|---|---|---|---|
| Number | (g/m²) | (g · mm) | (Newtons) | (40 cycles) |
| A | 17.5 | 838 | 38.4 | 3.75 |
| 1 | 16.0 | 481 | 30.2 | 4 |
| B | 15.9 | 291 | 20.6 | 4 |
| 2 | 16.2 | 174 | 22.2 | 4 |
| C | 15.4 | 767 | 33.5 | 2.75 |
| D | 17.0 | 620 | 35.0 | 2.75 |
| E | 18.0 | 408 | 41.0 | 2.75 |
| 3 | 16.0 | 720 | 30.2 | 3.75 |
| 4 | 16.0 | 410 | 38.7 | 2.75 |
| F | 14.6 | 446 | 29.6 | 5 |
| G | 14.5 | 340 | 36.6 | 5 |
| H | 15.8 | 203 | 34.1 | 5 |
| 5 | 15.9 | 410 | 21.9 | 4 |
| 6 | 16.2 | 222 | 23.6 | 4 |

Additionally, a portion of material that was produced in each of the Examples was evaluated for hand feel. Although, the mechanically softened materials of Examples 3 and 4 that included a softening agent had similar or slightly higher Cup Crush values than the corresponding mechanically softened materials without a softening agent, Examples E and H, respectively, e.g. Examples 3 and 4 had improved hand feel.

While the invention has been described in detail with respect to specific embodiments thereof, it will be appreciated that those skilled in the art, upon attaining an understanding of the foregoing may readily conceive of alterations to, variations of and equivalents to these embodiments. Accordingly, the scope of the present invention should be assessed as that of the appended claims and any equivalents thereto. It should be further noted that any patents, applications or publications referred to herein are incorporated by reference herein in their entirety.

We claim:

1. A method for producing a soft nonwoven web, the process comprising:
forming a mixture comprising:
(a) a thermoplastic; and
(b) an additive selected from the group consisting of polyethylene waxes, glyceryl monostearate, sorbitan tristearate, an olefinic thermoplastic elastomer, an amide having the chemical structure CH₃(CH₂)₇CH═CH(CH₂)ₓCONH₂ where x is selected from 5-15, and mixtures thereof;
forming the mixture into fibers; and
creating a nonwoven web from the fibers.

2. The method of claim 1, wherein the mixture comprises from about 0.05 to 5 weight percent of the additive based on the weight of the thermoplastic.

3. The method of claim 1, wherein the mixture comprises from about 0.05 to about 3 weight percent of the additive based on the weight of the thermoplastic.

4. The method of claim 1, wherein the mixture comprises from about 0.05 to about 1 weight percent of the additive based on the weight of the thermoplastic.

5. The method of claim 1, wherein the additive comprises an amide having the chemical structure CH₃(CH₂)₇CH═CH(CH₂)ₓCONH₂, where x is selected from 5-15.

6. The method of claim 1, wherein the additive comprises an amide having the chemical structure CH₃(CH₂)₇CH═CH(CH₂)ₓCONH₂, where x is selected from 6-12.

7. The method of claim 1, wherein the additive comprises an amide or a mixture of amides having the chemical structure CH₃(CH₂)₇CH═CH(CH₂)ₓCONH₂, where x is selected from 8-11.

8. The method of claim 1, wherein the additive comprises CH₃(CH₂)₇CH═CH(CH₂)₈CONH₂.

9. The method of claim 1, wherein the additive comprises CH₃(CH₂)₇CH═CH(CH₂)₁₁CONH₂.

10. The method of claim 1, wherein the method further comprises mechanically softening the nonwoven web or adding a surface treatment to the nonwoven web.

11. The method of claim 1, wherein the method further comprises stretching the nonwoven web by at least 5 percent.

12. A fiber having an exterior surface, the fiber comprising a composition that forms at least a portion of the exterior surface wherein the composition consists essentially of:
a) a thermoplastic;
b) from about 0.05 to about 5 weight percent of an additive selected from the group consisting of polyethylene waxes, glyceryl monostearate, sorbitan tristearate, an olefinic thermoplastic elastomer, an amide having the chemical structure CH₃(CH₂)₇CH═CH(CH₂)ₓCONH₂ where x is selected from 5-15, and mixtures thereof;
c) from 0 to about 10 weight percent of an opacifier;
d) from 0 to about 10 weight percent of an inorganic filler; and
e) from 0 to about 5 weight percent of a pigment.

13. The fiber of claim 12, wherein the composition comprises from about 0.05 to about 5 weight percent of the additive based on the weight of the weight of the polypropylene, copolymer of propylene or mixture thereof.

14. The fiber of claim 12, wherein the composition comprises from about 0.05 to about 3 weight percent of the additive based on the weight of the weight of the polypropylene, copolymer of propylene or mixture thereof.

15. The fiber of claim 12, wherein the additive comprises an amide having the chemical structure CH₃(CH₂)₇CH═CH(CH₂)ₓCONH₂, where x is selected from 5-15.

16. The fiber of claim 12, wherein the additive comprises an amide having the chemical structure CH₃(CH₂)₇CH═CH(CH₂)ₓCONH₂, where x is selected from 6-12.

17. The fiber of claim 12, wherein the additive comprises an amide having the chemical structure CH₃(CH₂)₇CH═CH(CH₂)ₓCONH₂, where x is selected from 8-11.

18. The fiber of claim 12, wherein the additive comprises CH₃(CH₂)₇CH═CH(CH₂)₈CONH₂.

19. The fiber of claim 12, wherein the additive comprises CH₃(CH₂)₇CH═CH(CH₂)₁₁CONH₂.

20. The fiber of claim 12, wherein the thermoplastic is selected from the group consisting of polyethylenes, polypropylenes, polyesters and mixtures thereof.

21. The fiber of claim 12, wherein the inorganic filler comprises an inorganic filler selected from the group consisting of zinc oxide, kaolin day, calcium carbonate, talc, attapulgite clay and mixtures thereof.

22. A nonwoven web comprising fibers, the fibers having an exterior surface and comprising a composition that forms at least a portion of the exterior surface wherein the composition consists essentially of:
a) a thermoplastic;
b) from about 0.05 to about 5 weight percent of an additive selected from the group consisting of polyethylene waxes, glyceryl monostearate, sorbitan tristearate, an olefinic thermoplastic elastomer, an amide having the chemical structure CH₃(CH₂)₇CH═CH(CH₂)ₓCONH₂ where x is selected from 5-15, and mixtures thereof;
c) from 0 to about 10 weight percent of an opacifier;
d) from 0 to about 10 weight percent of an inorganic filler; and
e) from 0 to about 5 weight percent of a pigment.

23. The nonwoven web of claim 22, wherein the nonwoven web has a Cup Crush value of less than about 600 grams per millimeter at a basis weight of 15 grams per square meter.

24. The nonwoven web of claim 22, wherein the nonwoven is thermally bonded and has a bond area of from about 10 percent to about 30 percent.

25. A laminate comprising the nonwoven web of claim 22.

26. An outercover for a disposable absorbent product comprising a laminate that comprises a nonwoven web of claim 22.

27. A liner for a disposable, absorbent product comprising the nonwoven web of claim 22.

28. The liner of claim 27 further comprising a skin wellness additive.

29. An absorbent product comprising the nonwoven web of claim 22.

30. An absorbent product comprising a barrier material comprising the nonwoven of claim 22.

31. A bandage comprising the nonwoven of claim 22.

32. A disposable product comprising the nonwoven of claim 22.

33. A nonwoven web comprising fibers, the fibers having an exterior surface and comprising a composition that forms at least a portion of the exterior surface wherein the composition consists essentially of:
a) a thermoplastic;
b) from about 0.05 to about 5 weight percent of an amide having the chemical structure CH₃(CH₂)₇CH═CH(CH₂)ₓCONH₂ where x is selected from 5-15, and mixtures thereof;
c) from 0 to about 10 weight percent of an opacifier;
d) from 0 to about 10 weight percent of an inorganic filler; and
e) from 0 to about 5 weight percent of a pigment.
